(19) United States
(12) Patent Application Publication
(10) Pub. No.: US 2005/0080201 A1
(43) Pub. Date: Apr. 14, 2005

(54) Method for lactic acid oligomerization

(76) Inventors: Remy Teissier, Francheville (FR); Serge Tretjak, Rouhling (FR); Elie Burtin, Longeville les Saint-Avold (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/503,375

(22) PCT Filed: Jan. 31, 2003
(86) PCT No.: PCT/FR03/00305

(30) Foreign Application Priority Data
Feb. 8, 2002 (FR) 02/01549

(51) Int. Cl. C08L 67/00; B01D 3/00

(52) U.S. Cl. 525/450; 203/12

(57) ABSTRACT

The invention concerns a method for continuously producing a dimmer-rich and tri-mer rich oligomeric lactic acid composition, starting with a lactic composition by eliminating water from said lactic acid composition. The invention is characterized in that it consists in: carrying out said elimination in an adiabatic reactor provided with a recycling loop, continuously introducing a lactic acid composition in a circulating starter reaction medium being brought to a temperature ranging between 120° C. and 180° C. and in eliminating the water vapour form.

This application claims benefit, under U.S.C. §119 or §365 of French Application No. 02/01549, filed Feb. 8, 2002; and PCT/FR03/00305 filed Jan. 31, 2003.

### FIELD OF THE INVENTION

The present invention relates to a method for obtaining an oligomeric lactic acid composition, said composition being suitable for preparing in particular an oligomeric composition of esters of lactic acid or for obtaining lactide which is the precursor of choice for obtaining polylactides used as biomaterials.

### BACKGROUND OF THE INVENTION

In the international patent application WO 01/47860-A1, a method is proposed for converting a lactic acid composition to a lactic acid ester composition, which consists, in a first step, of the oligomerization of a lactic acid composition.

Lactic acid composition means in particular any aqueous solution of lactic acid, regardless of its method of preparation and its properties, said solution, for example, presenting a highly variable dry matter content (DM) and lactic acid purity. It may relate in particular to trade solutions containing 50, 80, 88 or 90% of dry matter, with the understanding that such solutions are in fact mixtures of water, monomers, dimers and higher oligomers of lactic acid.

In said application WO 01/47860, the conversion of the lactic acid composition to an oligomeric lactic acid composition takes place by the removal of water which can advantageously be achieved by simple evaporation, in one or a plurality of steps, at a temperature of 100° C. to 170° C., at atmospheric pressure or under reduced pressure, until an oligomeric composition is obtained having a mean degree of polymerization (MDP) between 2 and about 30 and preferably between 3 and 10.

According to said application WO 01/47860, the preparation of an oligomeric composition having such an MDP offers the advantage of providing (of having) a limited water content and consequently facilitates its subsequent esterification.

The MDP is calculated by the following formula:
MDP=18/[100×90.08]/T−72 (1)
where T is the mass of lactic acid monomer (CH₃—CHOHCOOH, 90.08 g/mol) contained in 100 g of oligomeric lactic acid composition. This mass is determined after saponification (20 min at 100° C.) by excess caustic soda, of a given weight of sample (0.1 g to 0.3 g) of the oligomeric composition. After neutralization of the reaction mixture, the latter is rapidly analyzed by high performance liquid chromatography (HPLC) with refractometric detection. This analysis can be performed on a “SHODEX SH 1011” type cation exchange column using N/100 sulfuric acid as eluent. This technique serves to determine the mass of lactic acid monomer contained in the sample tested and, by simple calculation, the mass T contained in 100 g of oligomeric composition.

By way of example, an oligomeric lactic acid composition is obtained in application WO 01/47860 having an MDP of 5.9, which, if the preceding formula (1) is applied, corresponds to a mass of lactic acid T of 119.92.

The lactic acid oligomers and their distribution in the oligomeric lactic acid composition can be determined by gas chromatography GC on a Shodex KF 802.5 column (300 mm×8 mm) with THF at a flow rate of 1 ml/min with a PEG calibration (range: 14,500 to 350 daltons) with refractometric detection.

This removal of water carried out advantageously by simple evaporation can be achieved in practice in a rotary evaporator or in a simple heated reactor. However, the applicant has found that this procedure presents a number of drawbacks.

In fact, the applicant has observed overheating in the reactor which can cause an increase in the high molecular weight oligomers. The applicant also observed the presence of lactic acid in the water removed, hence a loss of raw material. These drawbacks are liable considerably to reduce the productivity of an industrial process and lead to a lack of reproducibility.

### SUMMARY OF THE INVENTION

The applicant has found a continuous method for obtaining an oligomeric lactic acid composition rich in dimer and in trimer, from a lactic acid composition by removal of water from said lactic acid composition, characterized in that this removal is carried out in an adiabatic reactor fitted with a circulation loop equipped with heating means, in that a lactic acid composition is continuously introduced into a circulating starter reaction medium, said reaction medium being heated to a temperature between 120° C. and 180° C. and, preferably, between 130° C. and 150° C., and in that the pure water is removed in vapor form.

According to the present invention, the oligomerization reactor is first loaded with a predetermined quantity of an oligomeric composition of starter lactic acid obtained in particular by a batch process.

The volumetric quantity introduced at the start can be between 20% and 80% of the reactor volume, and preferably, close to 50%.

According to the present invention, the circulation of the reaction medium is advantageously provided by a centrifugal pump placed on the circulation loop having an hourly delivery suitable for circulating between 20 and 100 times the reaction mass.

### BRIEF DESCRIPTION OF THE DRAWING

FIGURE 1 represents a device for practicing the method of the invention

### DETAILED DESCRIPTION OF THE INVENTION

The reaction medium is heated to a temperature as previously defined by means of a heat exchanger placed on the circulation loop.

The removal of water according to the present invention is carried out at a pressure equal to or lower than atmospheric pressure. This is generally done at a pressure between 100 mbar and 200 mbar. The water leaving the reactor in vapor form passes through an unchoking zone which can consist of a demister or of a distillation column.

According to the present invention, so-called “industrial”, “technical”, “food grade” or “pharmaceutical” grades of lactic acid compositions are used. Preferably, a lactic acid composition in water containing 88% by weight of lactic acid is used.

The oligomerization can be achieved in the presence of a homogeneous acidic catalyst such as H₂SO₄, H₃PO₄, methanesulfonic acid or paratoluenesulfonic acid, used in a weight quantity between 0.1% and 1% by weight of the quantity of dry lactic acid.

This method applies in particular to obtaining an oligomeric lactic acid composition comprising low molecular weight oligomers such as the dimer, trimer and tetramer. Preferably, the oligomeric lactic acid composition according to the present invention has an MDP between 3 and 10.

The method according to the present invention offers the advantage of obtaining linear oligomers with a narrow molecular weight distribution, without loss of raw material, that is, with a virtual absence of lactic acid in the recovered water.

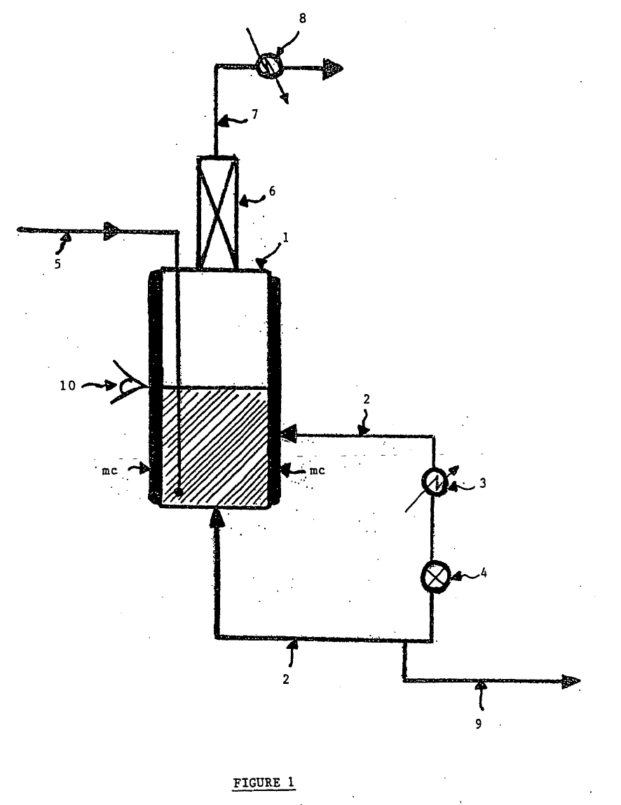

This method can be put into practice by means of a device shown schematically in FIG. 1.

This device is characterized in that it comprises:
an adiabatic reactor (1) consisting of at least one distillation column element equipped with heating mantles (hm), with a circulation loop (2) equipped with a heat exchanger (3) and a centrifugal pump (4);
a lactic acid composition feed (5).

The water leaving the reactor (1) in vapor form is introduced into an unchoking zone (6) from which it leaves at (7) and then passes through the heat exchanger (8) where it is condensed.

The oligomeric lactic acid composition leaves at (9).

The reactor is equipped with a level controller (10) by differential pressure measurement.

According to the present invention, the lactic acid composition feed is immersed in the reaction medium previously loaded into the reactor.

This method according to the invention offers great flexibility. The circulation rate of the reaction medium can be varied considerably, causing an excellent distribution of the heat within the reaction medium and avoiding overheating, thereby obtaining a narrow molecular weight distribution of the oligomers.

The unchoking zone serves to reduce the lactic acid evaporation rate, and serves to ensure the productivity of the industrial process.

The following examples illustrate the invention.

### EXAMPLE 1

### Apparatus

The oligomerization reactor (1) consists of two distillation column elements (height: 0.8 meter, diameter: 180 mm) equipped with their heating mantles (hm) to ensure the adiabaticity of the system.

The reaction medium is circulated by a centrifugal pump (4) delivering 1 m³/h, said reaction medium passes through an electric heat exchanger (3) with a heat exchange area of 0.15 m² delivering a maximum heating power of 6 kW.

The reactor is equipped with a level controller (10) by differential pressure measurement with nitrogen injection.

In the following examples, the reactor is filled to 50% of its volume.

The removed water passes through a distillation column element (6) of four theoretical trays and is recovered after condensation in a condenser (8) with an area of 1 m².

Starting lactic acid:

It has a total lactic acid content—LAC—of 88.7 and a free water content of 13.3%.

The LAC corresponds to the T in formula (1) mentioned above.

The mass of lactic acid monomer T contained in 100 g of oligomeric lactic acid compositions is determined by the method described above.

Preparation of a “starter” batch then continuous tests according to the invention:

About 25.8 kg of lactic acid are introduced and oligomerized in a batch for 5 hours in the following conditions:
T° C exchanger=135° C.,
Pressure=100 mbar,
Power=2.5 kW.

After 5 hours, the reactor temperature is about 133° C., and the introduction of 6.2 kg/h of the lactic acid composition into the reaction medium previously obtained is started. The pressure is maintained at 100 mbar. The water is recovered at an average rate of 1.6 kg/h. At the discharge of the centrifugal pump (4) the oligomer is withdrawn at a rate of 4.6 kg/h. The LAC of the oligomer is measured at 118%, corresponding to an MDP of 4.14 determined by the formula (1) in which T=118.

The production of oligomer was carried out for 50 hours.

### EXAMPLE 2 (Not According to the Invention)

Carried out in an identical reactor to the one in example 1, but the lactic acid is introduced into the top of the reactor, and the water removal circuit is direct, that is, without the column (6) of four theoretical trays. The operation is identical. When the reactor temperature reaches 133° C., the lactic acid is introduced at a rate of 6.26 kg/h. The water is recovered at a rate of 1.88 kg/h, and the oligomer at a rate of 4.38 kg/h containing 115% of LAC. The aqueous stream is found to contain about 18% of entrained lactic acid.

### EXAMPLE 3 (Not According to the Invention)

About 31 kg of lactic acid with 88.7% of LAC and 13.3% of water are introduced into a stirred reactor with a volume of 40 l heated by means of a double jacket and able to operate under vacuum. The mixture is heated with stirring, gradually reducing the pressure to 100 mbar. To reach the temperature of 135° C. in the reactor, the heat transfer fluid must be heated to 155° C. After 5 hours of reaction, the lactic acid is introduced into the top of the reactor at a rate of 6.3 kg/h. The water is recovered at a rate of 1.8 kg/h. An oligomer is obtained at a rate of 4.3 kg/h containing 113% of LAC.

1. A continuous method for obtaining an oligomeric lactic acid composition from a lactic acid composition by removal of water from said lactic acid composition, characterized in that this removal is carried out in an adiabatic reactor fitted with a circulation loop equipped with heating means, in that a lactic acid composition is continuously introduced into a circulating starter reaction medium, said reaction medium being heated to a temperature between 120° C. and 180° C., and in that the pure water is removed in vapor form.

2. The method as claimed in claim 1, characterized in that the circulating reaction medium is heated to a temperature between 130° C. and 150° C.

3. The method as claimed in claim 1, characterized in that the volumetric quantity of starter composition introduced into the reactor at the start is between 20% and 80% of the reactor volume.

4. The method as claimed in claim 3, characterized in that the volumetric quantity of starter composition introduced into the reactor at the start is close to 50% of the reactor volume.

5. The method as claimed in claim 1, characterized in that the reaction medium circulates in the apparatus consisting of the adiabatic reactor and its circulation loop between 20 times and 100 times per hour.

6. The method as claimed in claim 1, characterized in that the water is removed at a pressure equal to or lower than atmospheric pressure.

7. The method as claimed in claim 6, characterized in that the water is removed at a pressure between 100 mbar and 200 mbar.

8. A device suitable for putting the method into practice according to any one of claims 1 to 10, said device being characterized in that it comprises:
an adiabatic reactor (1) consisting of at least one distillation column element equipped with heating mantles (hm), with a circulation loop (2) equipped with a heat exchanger (3) and with a centrifugal pump (4);
a lactic acid composition feed (5);
an unchoking zone (6);
a water vapor discharger (7) fitted with a condenser (8);
a discharge of the oligomeric lactic acid composition (9);
a level controller (10).

9. The device as claimed in claim 8, characterized in that the lactic acid composition feed is immersed in the reaction medium previously loaded into the reactor (1).

10. The device as claimed in claim 8, characterized in that the unchoking zone is a distillation column.
